(19) United States
(12) Patent Application Publication
(10) Pub. No.: US 2003/0115366 A1
(43) Pub. Date: Jun. 19, 2003

(54) Asynchronous message delivery system and method

(76) Inventor: Brian R. Robinson, Mt. Laurel, NJ (US)

Correspondence Address: HEWLETT-PACKARD COMPANY, Intellectual Property Administration, P.O. Box 272400, Fort Collins, CO, 80527-2400, US

(21) Appl. No.: 10/023,590

(22) Filed: Dec. 18, 2001

(51) Int. Cl. G06F 15/16

(52) U.S. Cl. 709/248; 709/206

(57) ABSTRACT

The present invention comprises a method for delivering message data in an asynchronous messaging system. The method comprises specifying message data in a custom tag to be sent to a client from a server page, the server page that comprises a scripting language and extensible custom tag functionality, and the client operable to receive asynchronous messages. The method also comprises specifying attributes to be used with the tag to send the message data to one of a queue and a topic, and automatically delivering the message data to the one of the queue and the topic in the client upon execution of the server page. In a particular embodiment, the attributes are specified by using JNDI.

### TECHNICAL FIELD OF THE INVENTION

The present invention relates in general to telecommunications and, more particularly, to an asynchronous message delivery system and method.

### BACKGROUND OF THE INVENTION

Network systems such as the Internet now provide a ubiquitous environment for many applications. For example, electronic commerce is a growing industry that allows computer users to place orders through storefronts such as www.gap.com. Many technologies have been developed to support running these applications in a platform-independent manner, such as the JAVA language and ENTERPRISE JAVABEANS (EJB), developed by Sun Microsystems. A variety of messaging systems, server page, scripting language, agent, proxy, and tag technologies have also been developed.

One technology includes server page technology which allows programmers to design flexible server pages using scripting languages and scriptlets. Two examples of server page technologies include Active server pages(ASP) and JAVA Server Pages (JSP). JSPs are generated by logic that includes JAVA as the scripting language and extensible custom tag functionality. Another technology includes asynchronous messaging systems, one example of which is the JAVA Message Service (JMS).

It may be desirable, for example, to send data from a server page such as a JSP to another destination in a variety of situations. For example, suppose an online webstore needs to update its inventory after each processed sale, yet the inventory management system is across the globe. In that case, using a messaging system to asynchronously update the inventory may provide an attractive alternative. As one example, a server page technology such as JSP allows programmers to define custom tags, which may be grouped into tag libraries and reused in any number of JSP files. Custom tags allow complex programming logic to boil down to a set of simple tags, which JSP developers can easily use to develop content. Unfortunately, sending messages from JSP pages typically requires JAVA code to be written in a scriptlet in a JSP. Such a method requires an author to have JAVA programming knowledge, and to be familiar with application programming interfaces (APIs) such as the JMS API, and the JAVA Naming and Directory InterfaceTM (JNDI) API. Such a method suffers from unnecessary complexity, and may reduce the adaptability of messaging techniques to changes in system designs.

Although some recent methods have attempted to incorporate messaging system tag technology, such as JMS tags, with JSP technology, these methods may suffer from disadvantages. For example, these methods may not be able to support sending JMS messages via point-to-point as well as publish/subscribe messaging models. Such a disadvantage restricts the number of service providers that support such a technology and thus may reduce the effective transmission rates achievable with more compatible methods. Moreover, such a method is restricted to particular implementations of that messaging service, in this example JMS.

### SUMMARY OF THE INVENTION

From the foregoing, it may be appreciated that a need has arisen for asynchronously delivering message data. In accordance with the present invention, an asynchronous message delivery system and method are provided that substantially eliminate or reduce disadvantages and problems of conventional systems.

One aspect of the present invention comprises a method for delivering message data in an asynchronous messaging system. The method comprises specifying the message data in a custom tag to be sent to a client from a server page that comprises a scripting language and extensible custom tag functionality, and the client operable to receive asynchronous messages. The method also comprises specifying attributes to be used with the tag to send the message data to one of a queue and a topic, and automatically delivering the message data to the one of the queue and the topic in the client upon execution of the server page. In a particular embodiment, the attributes are specified by using JNDI.

Another aspect of the present invention comprises a system for delivering message data in an asynchronous messaging system. The system comprises a server and logic operatively associated with the server. The logic is operable to execute a server page that comprises a scripting language and extensible custom tag functionality and to cause automatic delivery of the message data to one of a queue and a topic upon execution of the server page. The message data is encoded in a custom tag in the server page, and the custom tag uses attributes to specify a destination of the message data to the one of the queue and the topic.

Another aspect of the present invention comprises a system for receiving message data in an asynchronous messaging system. The system comprises a client operable to receive asynchronous messages and a message retrieval application programming interface operatively associated with the client. The message retrieval application programming interface is operable to retrieve the message data from one of a queue and a topic. The message data is encoded in a custom tag in a server page that comprises a scripting language and extensible custom tag functionality and is automatically delivered to the one of the queue and the topic upon execution of the server page.

### BRIEF DESCRIPTION OF THE DRAWINGS

For a more complete understanding of the present invention and the advantages thereof, reference is now made to the following description taken in conjunction with the accompanying drawings, wherein like reference numerals represent like parts, and in which:

FIG. 1 is an example of a block diagram of a system that may be used for delivering message data according to an embodiment of the present invention;

FIG. 2 illustrates an example of a method for asynchronously delivering message data according to an embodiment of the present invention; and

FIG. 3 graphically illustrates a representation of an example of a custom tag that may be utilized according to an embodiment of the present invention.

### DETAILED DESCRIPTION OF THE DRAWINGS

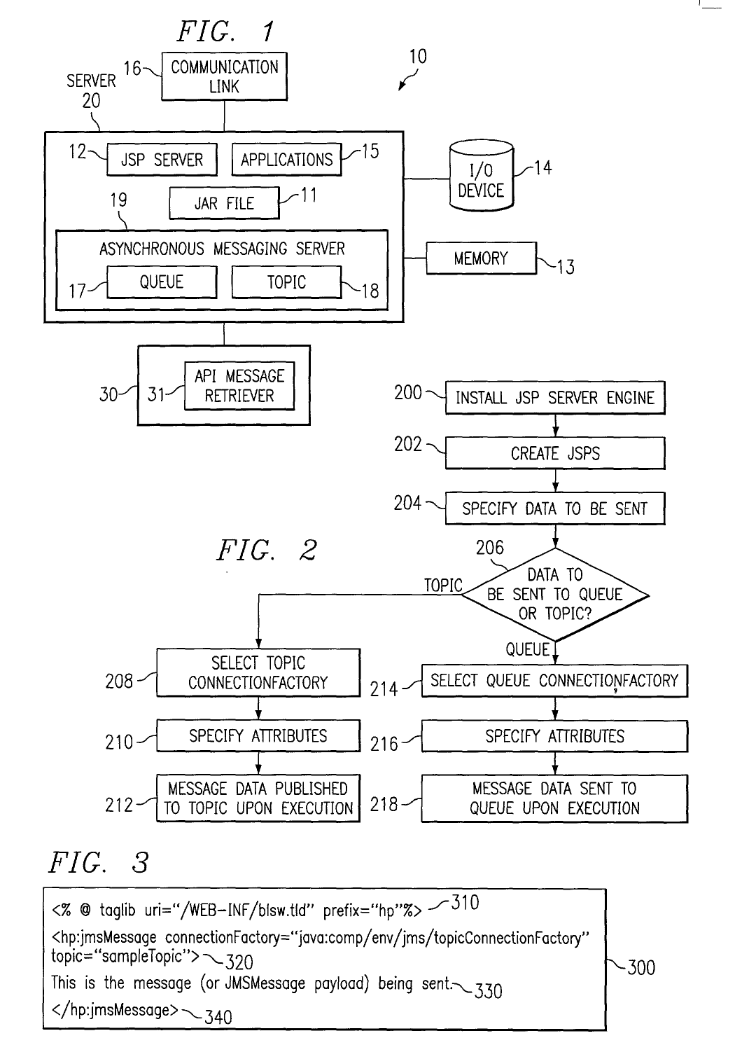

FIG. 1 is an example of a block diagram of a system that may be used for delivering message data according to an embodiment of the present invention. In the embodiment illustrated in FIG. 1, system 10 includes a server 20 and at least one client 30. Generally, the present invention provides for message data in an asynchronous messaging system to be sent from a server page that includes a scripting language and extensible custom tag functionality (such as a JSP) upon execution of the server page. One advantage of the present invention is that the invention provides for the asynchronous delivery of message data to client 30. As one example, the present invention may be particularly useful in online applications where message data may be sent in a custom tag via a server page such as a JSP to a distributor or a shipper such as Federal Express after an order has been placed by a customer. The invention avoids storing the message in a database, and utilizes an asynchronous messaging technology such as JMS and server pages that include a scripting language, such as JAVA, and extensible custom tag functionality. Such features may provide a convenient and flexible way to asynchronously deliver messages that is compatible with a variety of implementations of JMS and other systems. Such an advantage may also improve the services and/or rates available to customers, and may allow faster processing.

System 10 includes one or more clients 30, which areoperable to receive asynchronous messages and are coupled to server 20 by one of a variety of methods, including wireless and conventional landline communication links. Server 20 may be a general or a specific purpose computer and includes JAVA ARchive (JAR) file 11, a memory 13, which may include random access memory (RAM) and read-only memory (ROM) and may, in some embodiments, include a JSP server 12. For example, JSP server 12 may be used to send messages to a queue 17 or topic 18, each of which is associated with an asynchronous messaging server 19, which client 30 can access. Specifically, server 20 may be used to execute one or more applications 15 that include logic, or application software, that is operatively associated with server 20 and that utilizes messaging system and server page technologies such as, but not limited to, JMS and JSP. Applications 15 may be stored in memory 13 and/or an input/output (I/O) device 14, which may be any suitable storage media. Applications 15 may comprise a collection of server pages such as JSPs. For example, when a JSP is executed, JMS tags encoded within the JSP cause the message data in the tag to be automatically sent to one of a queue and a topic, as specified in the JMS tag. These tags may reside in JSPs in an application 15 on server 20, and message data may be asynchronously delivered and/or retrieved from topic 18 or queue 17 by client 30 using an application programming interface (API) message retriever 31. Messages delivered may be displayed using a display (not explicitly shown) and/or stored in memory 13 and/or input/output device 14. In the embodiment illustrated in FIG. 1, one or more topics 18 and one or more queues 17 reside on an asynchronous messaging server 19, but may in different embodiments reside elsewhere, such as on client 30, or on a separate asynchronous messaging server 19.

Client 30 may be any client operable to receive asynchronous messages such as a workstation, or wireless device. For example, a client may receive message data in an asynchronous messaging system such as JMS, or other message-oriented middle-ware systems, from a queue, or subscribe to message data from a topic. In this embodiment, client 30 includes API message retriever 31, which is operable to retrieve messages from queue 17 and/or topic 18 on server 20. As an example, API message retriever 31 may be used to display the message on a display (not explicitly shown).

A description of asynchronous messaging technology may be illustrative. As one example, JMS messaging is well-known and provides the ability to transfer messages according to the Java Message Service 1.0.2 specification. First, a JMS ConnectionFactory may be found via a JNDI lookup, or by creation of objects through the use of reflection. Reflection may be used as an alternative to JNDI that is used to invoke, for example, methods or constructors for a given class. An attribute of the JMS tag tells it what the class name of a ConnectionFactory is to be instantiated. When using JNDI, for example, a system administrator defines and configures one or more connection factories, and server 20 adds them to a JNDI space during startup. A connection factory encapsulates connection configuration information, and enables JMS applications to create a connection. Using the connection factory, the connection is then created. A connection represents an open communication channel between an application and the messaging system. The connection is then used to create a session, which is a serial order in which messages are produced and consumed, and can create multiple message producers and message consumers.

According to aspects of the present invention, message data may be delivered to a destination that is either a queue 17 or a topic 18, both of which encapsulate the address syntax for a specific provider. These destinations may be found in JNDI, or by the use of reflection. For example, topics 18 may be worklists, audit or error topics and which may display worklists, audit or error messages. Queues 17 may be events with event messages. On the client side, destinations are handles to the objects on the server 20. The methods return only the destination names. To access destinations for messaging, message producers and consumers may be created that can attach to destinations.

JMS supports two messaging styles: point-to-point messaging and publish-and-subscribe messaging. Point-to-point messaging includes two applications to communicate with each other using queue 17, which channels the messages. An application interested in sending a message begins with a queue connection factory that obtains a queue connection, which creates a queue session, the application's personal window into the connection. Client 30 uses that session to create a message producer (such as a QueueSender), which sends messages to queue 17. A receiving application 31 may similarly obtain a queue connection factory, a queue connection, and a queue session, but uses the session to create a message consumer (such as a QueueReceiver) to receive messages the queue 17. JSP server 12 may be used to send these messages to queue 17.

The publish-and-subscribe model is centered around topic 18. In this case, client 30 may be considered a publisher. A publisher uses a topic connection factory to create a topic connection, which then is used to create a topic session that provides the publisher with a personal window into the topic connection. The publisher may use the topic session to create a message producer (such as a TopicPublisher), which publishes messages to topic 18. A subscribing application 31 similarly obtains a topic connection factory, a topic connection, and a topic session, but uses the session to create a message consumer (such as a TopicSubscriber) that subscribes to messages from topic 18.

Data processing may be performed using special purpose digital circuitry contained either in server 20 or in a separate device. Such dedicated digital circuitry may include, for example, application-specific integrated circuitry (ASIC), state machines, VLSI logic, as well as other conventional circuitry. Server 20 may also include a portion of a computer adapted to execute any of the well-known MS-DOS, PC DOS, OS2, UNIX, MAC OS, and WINDOWS operating systems or other operating systems including unconventional operating systems. Server 20 may also be coupled to a communication link 16 that may be connected to a computer network, a telephone line, an antenna, a gateway, or any other type of communication link.

Server 20 may include one or more JAR files 11, which may be organized as desired, depending on the implementation. JAR file 11 is a file format that may be used for aggregating many files, include tag libraries, into one, and is based on the popular ZIP file format. JAR file 11 may be used as an archive and/or so that JAVA applets and their requisite components (class files, images and sounds) may be downloaded to a browser in a single transaction, rather than opening a new connection for each piece. Class files within JAR file 11 may be used, for example, to publish messages to topics 18 or send to queue 17 using JMS tag class definitions that are contained within JAR file 11. One or more JAR files 11 may include libraries that are necessary to utilize any implementations of JMS and/or JSP and the taglib containing the JMS tag.

Any type of message data may be delivered in accordance with the present invention, including text or serialized objects. One example for such data is discussed in further detail in conjunction with FIG. 3. The particular implementation for delivering the data may depend on the implementation of JMS. For example, SONICMQ, available from Sonic Software, and IBUS, from Softwired, Inc., typically require various attributes for sending data to queue 17 or publishing the data to topic 18. One method for delivering this data is discussed in further detail in conjunction with FIG. 2.

Although the invention contemplates numerous methods for implementing the method as is discussed below, an example may be illustrative before discussing the steps referred to in FIG. 2. For example, in a particular embodiment, server 20 may utilize a software architecture that includes applications 15, and that may be logically composed of several classes and interfaces. These classes may operate in a distributed environment and communicate with each other using distributed communications methods, and may include a distributed component architecture such as Common Object Request Broker Architecture (CORBA) and EJB™.

Each method tag may be implemented as a class. Examples for methods for this class may be found in an interface in JSP specifications (JavaServer Pages 1.1 and JavaServer Pages 1.2) For example, a JSP text file may be executed by JSP server 12. These methods are known in the art and based on the JSP Specification and tag libraries, or taglibs. The information for each tag may be found in a .tld file. Examples for a .tld file and a custom tag 300 that may be executed in a JSP file are discussed in conjunction with FIG. 3.

In this example, a method may in a particular embodiment generally utilize a tag handler class that uses an instance of another object that may send or publish JMS message data to asynchronous messaging server 19, such as a MessageUtils object. A MessageUtils object may be either a TopicUtils object, QueueUtils object, or another extension of MessageUtils. The tag handler class may create and use the appropriate MessageUtils extension to send a JMS message based on a combination of attributes that are specified on the tag. These attributes are discussed in further detail in conjunction with Table I, and depend on the implementation of the asynchronous messaging system (such as JMS) used.

FIG. 2 illustrates an example of a method for asynchronously delivering message data using a server page that includes a scripting language and extensible custom tag functionality according to an embodiment of the present invention. For example, asynchronous messaging technology such as JMS utilizes a ConnectionFactory to establish a connection and begin a session. This technology then allows message data to be sent to a queue or published to a topic. In this example, JMS utilizes a variety of attributes to asynchronously deliver message data, according to the implementation, that are discussed in further detail in conjunction with TABLE I, including topic, queue, ConnectionFactory, args, deliveryMode, timeToLive, priority, and debug.

Although FIG. 2 illustrates a particular embodiment that discusses an example of a method utilizing JSP and JMS technologies, the method generally includes providing custom tags in a server page that includes a scripting language and extensible custom tag functionality (such as a JSP) and executing the server page to deliver the message data. Various embodiments may utilize fewer or more steps, and the method may be performed using a number of different implementations, depending on the application. The method begins in step 200, where a server engine, such as JSP server engine 12, may be installed on server 20 where messages are being sent to queue 17. In step 202, server pages may be created as desired. For example, a shipping company may include a variety of product pages designed using JSPs. In step 204, the message data to be sent may be specified. For example, when orders from the shipping company are sent via an asynchronous messaging technology in Xtended Markup Language (XML), message data may be sent to a queue for a shipper that includes the order number, customer's address and other relevant information.

In step 206, the method then queries whether the message data is to be sent to a queue or published to a topic. If, in step 206, the data is to be sent to a topic, in step 208, the method selects a ConnectionFactory, and then specifies attributes for the selected ConnectionFactory in step 210. When the server page is executed in step 212 by known methods, the message data is automatically published to the topic. One advantage of the method is that the method contemplates allowing all messaging system interfaces to be used at runtime, which may reduce interpretation time that would otherwise be necessary with conventional methods. For example, where the messaging system is JMS, a ConnectionFactory may currently use one of two methods: reflection and JNDI. The method is operable to use both of these methods, as desired. Each of these methods requires a particular attribute list, and/or locations and identifiers of objects or arrays to be sent, according to well-known specifications. An exemplary list of specified attributes for topics is included in TABLE 1.

TABLE 1

| No. | Specified Attributes | Comments |
|---|---|---|
| 1. | Topic, ConnectionFactory, args | ‘args’ attribute is |
| | | specified only where |
| | | necessary for a particular |
| | | implementation of an |
| | | asynchronous messaging system |
| | | such as JMS. This combination |
| | | of attributes uses reflection |
| | | in obtaining an instance of |
| | | the ConnectionFactory |
| 2. | Topic, ConnectionFactory | |
| 3. | Topic, ConnectionFactory | ‘connectionFactory’ argument is |
| | (JNDI) | specified in an implementation |
| | | of a server page such as a JSP |
| | | where a ConnectionFactory |
| | | requires a JNDI lookup string |
| | | for the ConnectionFactory |
| | | attribute |
| 4. | Topic, ConnectionFactory, args, | ‘args field is specified only |
| | deliveryMode, priority, | where necessary |
| | timeToLive | |
| 5. | Topic, ConnectionFactory | |
| | (JNDI), | |
| | deliveryMode, priority, | |
| | timeToLive | |
| 6. | Topic, ConnectionFactory, | |
| | deliveryMode, priority, | |
| | timeToLive | |
| 7. | Queue, ConnectionFactory, args | |
| 8. | Queue, ConnectionFactory, args, | |
| | deliveryMode, priority, | |
| | timeToLive | |
| 9. | Queue, ConnectionFactory | |
| 10. | Queue, ConnectionFactory | |
| | (JNDI) | |
| 11. | Queue, ConnectionFactory, | |
| | deliveryMode, priority, | |
| | timeToLive | |
| 12. | Queue, ConnectionFactory | |
| | (JNDI), | |
| | deliveryMode, priority, | |
| | timeToLive | |

The attributes and/or arguments, or “args,” illustrated in TABLE 1 may be used in a variety of implementations, according to the application. For example, codes may be inserted into a server page text file utilizing formats that have been included as examples for various implementations and applications as illustrated in TABLE 1. A new instance of a ConnectionFactory class may be instantiated. Because a ConnectionFactory may be instantiated through reflection or obtained through JNDI, and because there are many implementations of server pages, there may be additional attribute calls that may be used, whether now known, or developed in the future, depending on the application. As another example, args may be used to pass in an array of objects. For example, where a reflection is used instead of finding a ConnectionFactory through JNDI, this array of objects may be necessary, depending on the implementation of the asynchronous messaging system, such as JMS. As another example, a constructor may or may not have any args. Usually the definition of a constructor includes no args, but in some implementations of messaging systems such as JMS, such as IBUS, constructors require args.

If data is to be sent to a queue in step 206, the method proceeds to step 214. In step 214, the method selects a ConnectionFactory, and then specifies attributes for the selected ConnectionFactory in step 216. In step 218, the message data may be automatically sent to a queue upon execution of the server page.

FIG. 3 graphically illustrates a representation of an example of a custom tag that may be utilized according to an embodiment of the present invention. JSP code 300 is illustrated in this embodiment as an example of one use of a JMS tag, and may be inserted into a server page. JSP code 300 includes header information 310, custom tag usage 320, message text 330, and end tag usage indicator 340. Header information 310 provides information for the tag to be found in a certain library file, which may be a .tld file. In this example, the tag library information may be found in /WEB-INF/blsw.tld. Tag usage 320 is a particular implementation of example number 3 illustrated in TABLE 1. That is, the method will publish the message data to a topic named “sampleTopic”, and utilizes JNDI to invoke methods for a ConnectionFactory class to be found under the name “java:comp/env/jms/topicConnectionFactory” as its attributes. Message text 330 will be sent upon execution of JSP code 300 in the server page, and the end of message text 330 is indicated by end tag usage indicator 340.

Execution of one or more server pages such as JSPs provides message data to be sent from the server pages. One advantage of the present invention is that the invention may allow online sites such as storefronts to reduce or remove their dependency on batches or scripts that are typically required with traditional systems to send data back and forth. Here, message data that is sent from a custom tag allows message data to be provided to a queue or topic as needed. The present invention provides interoperability between a variety of implementations and platforms. For example, the present invention allows reflection and JNDI to be used as desired, regardless of the JMS implementation employed.

What is claimed is:

1. A method for delivering message data in an asynchronous messaging system, comprising:
specifying message data in a custom tag to be sent to a client from a server page, that comprises a scripting language and extensible custom tag functionality, and the client operable to receive asynchronous messages;
specifying attributes to be used with the tag to send the message data to one of a queue and a topic; and
automatically delivering the message data to the one of the queue and the topic in the client upon execution of the server page.

2. The method of claim 1, wherein the client is a wireless device.

3. The method of claim 1, further comprising specifying the attributes by using the attributes to identify an instance of a software class to be obtained by using an interface distributed under the name JNDI.

4. The method of claim 1, further comprising specifying the attributes by using the attributes to identify an instance of a software class to be created usingreflection.

5. The method of claim 1, further comprising specifying the attributes as deliveryMode, priority, and timeToLive.

6. The method of claim 1, wherein the scripting language comprises software code implemented by employing the language distributed under the name JAVA.

7. The method of claim 1, wherein the asynchronous messaging system comprises software code that is distributed under the name JAVA Message Service.

8. A system for delivering message data in an asynchronous messaging system, comprising:
a server; and
application software operatively associated with the server and operable to
execute a server page that comprises a scripting language and extensible custom tag functionality; and
cause automatic delivery of the message data to one of a queue and a topic upon execution of the server page; and
wherein the message data is encoded in a custom tag in the server page, and the tag uses attributes to specify a destination of the message data to the one of the queue and the topic.

9. The system of claim 8, further comprising a client coupled to the server and operable to receive asynchronous messages and the message data.

10. The system of claim 8, wherein the topic and the queue reside on the server.

11. The system of claim 8, wherein the topic and the queue reside on a second server.

12. The system of claim 8, further comprising a JSP server resident on the server, the JSP server operable to send the message data to the queue or the topic.

13. The system of claim 8, further comprising a JSP server resident on a second server, the JSP server operable to send the message data to the queue or the topic.

14. The system of claim 8, wherein the attributes comprise deliveryMode, priority, and timeToLive.

15. The system of claim 8, wherein the attributes identify an instance of one of the group consisting of a software class to be created using reflection and a software class to be obtained using an interface distributed under the name JNDI.

16. The system of claim 8, wherein the scripting language comprises software code implemented by employing the language distributed under the name JAVA.

17. The system of claim 8, wherein the asynchronous messaging system comprises software code that is distributed under the name JAVA Message Service.

18. A system for receiving message data, comprising:
a client operable to receive asynchronous messages; and
a message retrieval application programming interface operatively associated with the client and operable to retrieve message data from one of a queue and a topic; and
wherein the message data is encoded in a custom tag in a server page that comprises a scripting language and extensible custom tag functionality and is automatically delivered to the one of the queue and the topic upon execution of the server page.

19. The system of claim 18, wherein the custom tag uses attributes to specify a destination of the message data to the one of the queue and the topic.

20. The system of claim 19, wherein the attributes comprise deliveryMode, priority, and timeToLive.

21. The system of claim 18, wherein the client is a wireless device.

22. The system of claim 18, wherein additional message data is encoded in the custom tag and is automatically delivered to the one of the queue and the topic upon execution of the server page.

23. The system of claim 18, wherein at least one of the topic and the queue reside on a server coupled to the client.

24. The system of claim 18, wherein the attributes identify an instance of a software class to be created usingreflection.

25. The system of claim 18, wherein the attributes identify an instance of a software class to be obtained using an interface distributed under the name JNDI.

26. The system of claim 18, wherein the message retrieval application programming interface comprises a browser.

27. The system of claim 18, wherein the scripting language comprises software code implemented by employing the language distributed under the name JAVA.

28. The system of claim 18, wherein the asynchronous messaging system comprises software code that is distributed under the name JAVA Message Service.
